(19) United States
(12) Patent Application Publication
(10) Pub. No.: US 2020/0107534 A1
(43) Pub. Date: Apr. 9, 2020

(54) Mosquito Killer

(71) Applicant: Ningbo Dayang Industry and Trade Co., Ltd., Ningbo, Zhejiang (CN)

(72) Inventors: Jun Zheng, Ningbo (CN); Yuanai Ning, Boyang County (CN)

(21) Appl. No.: 16/343,457

(22) PCT Filed: Jun. 12, 2018
(86) PCT No.: PCT/CN2018/000222

§ 371 Date: Apr. 19, 2019

(30) Foreign Application Priority Data
May 24, 2017 (CN) 201720587543.7

(51) Int. Cl. A01M 1/08; F21V 33/00

(52) U.S. Cl. CPC A01M 1/08; A01M 2200/012; F21V 33/00

(57) ABSTRACT

Disclosed is a mosquito killing illumination device, comprising a housing (1) and a control unit. The housing comprises an illumination part (101) and a mosquito killing part (102), wherein an illumination lamp assembly is arranged in the illumination part (101); and a side wall of the mosquito killing part (102) is provided with a through hole (103) for a mosquito to fly into, and a mosquito enticing lamp (2) and a draught fan (3) are arranged in the mosquito killing part. The control unit controls the operation of the illumination lamp assembly, mosquito enticing lamp (2) and draught fan (3). The illumination device has a good mosquito killing effect and prevents a user from being bitten by a mosquito.

### TECHNICAL FIELD

This utility model refers to a mosquito killer in the domain of lighting industry.

### TECHNICAL BACKGROUND

Due to phototaxis, the winged insects like mosquito prefer flying to every place that has light. To prevent mosquito bites and gathering of winged insects, people are devoted to research and development of mosquito lamps, such as the mosquito killer which kills mosquitoes by using optic fiber as inducer and high-voltage electric hood. The table lamp is furnished with a little fan, mosquito-repellent incense stand. The mosquito killer above kills mosquitoes in a single way, unable to prevent people from mosquito bites effectively.

### CONTENTS OF THE UTILITY MODEL

The technical problem this utility model needs to solve is to offer a mosquito killer which plays an effective role in killing mosquitoes so that people can be protected from mosquito bites.

The technical solution of this utility model is to put forward a mosquito killer equipped with following structure. The mosquito killer is composed of shell and control unit. The shell is comprised of a luminous body, which is equipped with light modules, and a mosquito killing part, which is furnished with holes for mosquitoes at the sidewall as well as a mosquito inducer and a fan. The control unit is intended to control the light modules, and mosquito inducer.

As compared with existing technologies, the mosquito killer characterized by the structure above has following advantages.

Thanks to the mosquito killing part, the mosquito killer is able not only to provide light due to lamp, but also to kill mosquitoes. Inside the mosquito killing part there is a mosquito inducer and a fan. As the mosquito inducer attracts the mosquito near the device, the fan will force mosquitoes into the shell and dry them. The combined use of the fan and mosquito inducer can kill mosquitoes effectively in an environmentally-friendly way so that users will be protected from mosquito bites and sleep better.

To make improvements, the shell of the mosquito killer is armed with an opening at the bottom, where the luminous body is designed, and the mosquito killing part is located between the shell's inner wall and the luminous body. This structure is simple and the design is also reasonable.

To make improvements, the mosquito inducer and the fan are fixed within the shell, with the inducer above the fan. The fan's air inlet goes upward and air outlet goes downward. This structure is simple and the design is also reasonable.

To make improvements, the fan is equipped with a rotor and a bracket which is connected with the inner wall of the shell, with the rotor inside the bracket. With the help of this structure, the air has to pass along the rotor and so does the mosquitoes. Thus, the mosquitoes will be killed effectively.

To make improvements, there is a mosquito box within the shell and below the fan. At the presence of this structure, the mosquito box can save the mosquitoes killed.

To make improvements, the convex edge of the luminous body's shell appears like a loop, with its upper end linked to the lower end of the fan. The loop has multiple holes at its side wall. This structure is simple and therefore can be assembled easily.

To make improvements, there is space between side wall of the luminous body and the inner wall of the shell, and the annular mosquito box is located within the space above. This structure is simple and the mosquito box can be opened without difficult when there is a need to check the mosquitoes.

To make improvements, there is a slot at the upper end of the mosquito box's outer wall as well as a block on the inner wall of the shell, with the block inserted in the slot. With the use of this structure, the mosquito box and the shell can be connected easily due to the simple structure and easy installation.

To make improvements, there are several air vents at the bottom of the mosquito box. This structure will assure smooth air flow.

### EXPLANATIONS ON FIGURES

FIG. 1 Tridimensional diagram of mosquito killer in this utility model

FIG. 2 Sectional view of mosquito killer in this utility model

FIG. 3 Tridimensional diagram of the mosquito killer's shell in this utility model

FIG. 4 Tridimensional diagram of the mosquito killer's mosquito box in this utility model

According to the figures: 1—shell; 101—luminous body, 102—mosquito killing part, 103—hole, 104—block, 2—mosquito inducer, 3—fan, 301—rotor, 302—bracket, 4—mosquito box, 401—slot, 402—air vent, 5—loop, 501—ventilator

### SPECIFIC IMPLEMENTATION MODE

Technical solutions of this utility model are further described in combination with specific implementation modes and figures, but this utility model goes beyond these examples.

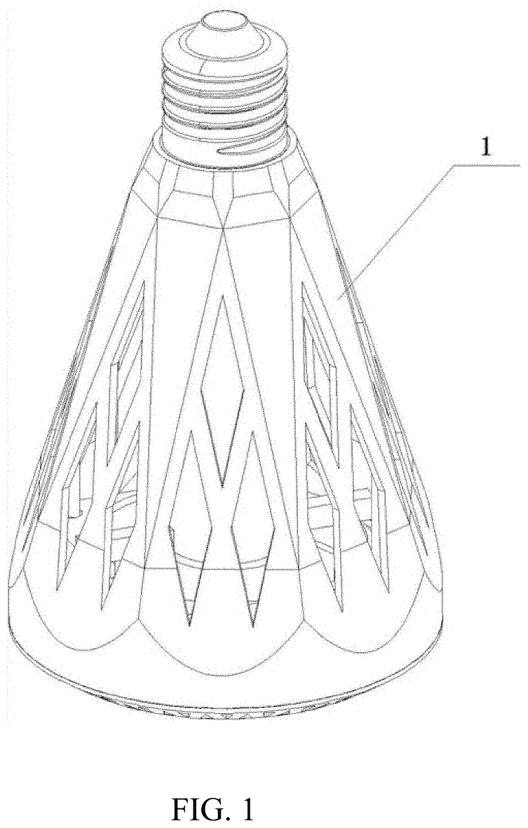

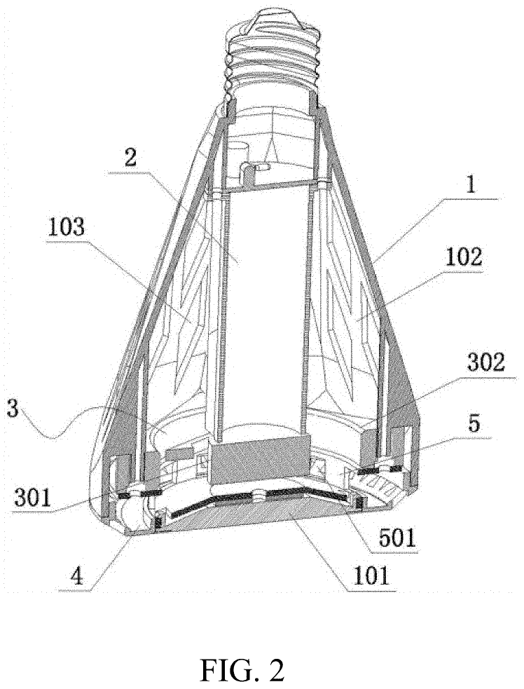

According to FIGS. 1 and 2, the mosquito killer of this utility model consists of shell 1 and control unit. The shell 1 is composed of a luminous body 101, which is equipped with light modules, and a mosquito killing part 102, which is furnished with holes 103 for mosquitoes at the sidewall as well as a mosquito inducer 2 and a fan 3. The control unit is intended to control the light modules, mosquito inducer 2, and fan 3. The mosquito killer plays an effective role in killing mosquitoes to protect users from mosquito bites.

As the mosquito inducer attracts the mosquito near the device, the fan will force mosquitoes into the shell and dry them. The combined use of the fan and mosquito inducer can kill mosquitoes effectively in an environmentally-friendly way so that users will be protected from mosquito bites and sleep better.

Based on the structure above, this utility model makes further improvements.

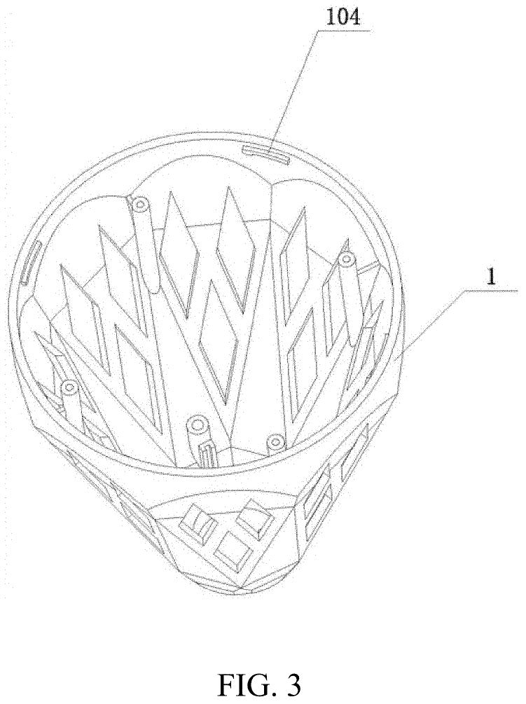

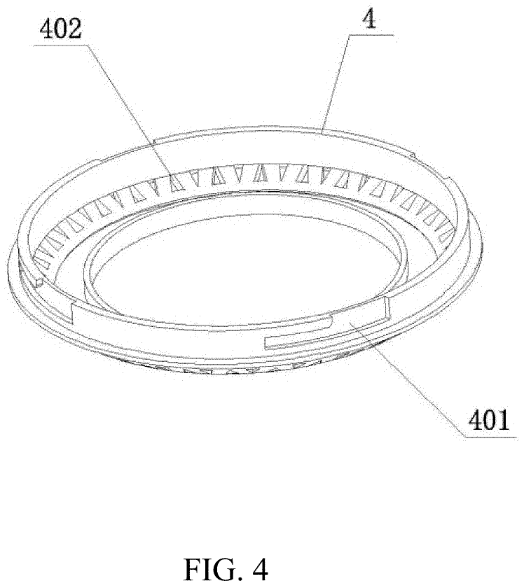

As revealed by FIGS. 3 and 4, the shell 1 of the mosquito killer is armed with an opening at the bottom, where the luminous body 101 is designed, and the mosquito killing part 102 is located between the shell's 1 inner wall and the luminous body 101. The mosquito inducer 2, plus the fan 3, is fixed within the shell 1 and above the fan whose air inlet goes upward and air outlet goes downward.

The fan 3 is equipped with a rotor 301 and a bracket 302 which is connected with the inner wall of the shell 1, with the rotor 301 inside the bracket 302. There is a mosquito box 4 within the shell 1 and below the fan 3.

The convex edge of the luminous body's 101 shell 1 appears like a loop 5, with its upper end linked to the lower end of the fan 3. The loop 5 has multiple holes 501 at its side wall.

There is space between side wall of the luminous body 101 and the inner wall of the shell 1, and the annular mosquito box 4 is located within the space above. There is a slot 401 at the upper end of the mosquito box's 4 outer wall as well as a block 104 on the inner wall of the shell 1, with the block 104 inserted in the slot 401. There are several air vents 402 at the bottom of mosquito box 4.

The operating principle of the mosquito killer is shown as follows: as the mosquito inducer 2 and fan 3 are started, the fan 3 can force mosquitoes into the shell 1 and dry them; then, the mosquitoes will be killed by electric shock of mosquito inducer 2 and fall within the mosquito box 4. The mosquito box 4 can be opened and cleaned when the box is full of mosquitoes.

Below is about how the control unit of the mosquito killer works:

Light will be offered when the switch of the control unit is pressed, and at this moment the switch remains at the first gear. The control unit can activate lighting function by controlling the lamp.

The killing function will be activated when the switch at the second gear is pressed again. The control unit will activate the function of lighting and killing mosquitoes at the same time by controlling mosquito inducer and fan.

When there is only a need to kill mosquitoes, press the switch at the third gear again. Then, the control unit will turn off the light and activate the function of killing mosquitoes, and the mosquito inducer and the fan will still work.

The control unit will control the mosquito inducer and fan to stop working when switch at the fourth gear is pressed.

1. A mosquito killer comprising: a shell; a control unit, with the shell including a luminous body equipped with light modules; and a mosquito killing part including holes for mosquitoes at a sidewall, a mosquito inducer, and a fan, with the control unit controlling the light modules, the mosquito inducer, and the fan, with the mosquito killer playing an effective role in killing the mosquitoes to protect users from mosquito bites.

2. The mosquito killer of claim 1, wherein the shell is armed with an opening at a bottom, and wherein the mosquito killing part is located between an inner wall of the shell and the luminous body.

3. The mosquito killer of by claim 2, wherein the mosquito inducer is fixed within the shell and above the fan whose air inlet goes upward and air outlet goes downward.

4. The mosquito killer of claim 3, wherein the fan is equipped with a rotor and a bracket connected with the inner wall of the shell, with the rotor inside the bracket.

5. The mosquito killer of claim 3, further comprising a mosquito box within the shell and below the fan.

6. The mosquito killer of claims 3, wherein a convex edge of the luminous body is configured as a loop, with an upper end of the convex edge linked to a lower end of the fan, and wherein the loop has multiple holes at a side wall.

7. The mosquito killer of claim 5, further comprising a space between a side wall of the luminous body and an inner wall of the shell, and wherein the mosquito box is located within the space.

8. The mosquito killer of claim 7, further comprising a slot at an upper end of an outer wall of the mosquito box; and a block on an inner wall of the shell, with the block inserted in the slot.

9. The mosquito killer of claim 7, wherein the mosquito box includes several air vents at a bottom.

10. The mosquito killer of claims 4, wherein a convex edge of the luminous body is configured as a loop, with an upper end of the convex edge linked to a lower end of the fan, and wherein the loop has multiple holes at a side wall.

11. The mosquito killer of claims 5, wherein a convex edge of the luminous body is configured as a loop, with an upper end of the convex edge linked to a lower end of the fan, and wherein the loop has multiple holes at a side wall.

12. The mosquito killer of claim 8, wherein the mosquito box includes several air vents at a bottom.
